(19) United States
(12) Patent Application Publication
(10) Pub. No.: US 2016/0346993 A1
(43) Pub. Date: Dec. 1, 2016

(54) METHOD FOR ASSEMBLING AN RFID DEVICE

(71) Applicant: NXP B.V., Eindhoven (NL)

(72) Inventor: Martin Weinberger, Munchen (DE)

(73) Assignee: NXP B.V., Eindhoven (NL)

(21) Appl. No.: 14/724,550

(22) Filed: May 28, 2015

(51) Int. Cl. B29C 65/48; G06K 19/077; B29C 65/02

(52) U.S. Cl. CPC B29C 65/48; B29C 65/02; G06K 19/0775; G06K 19/07773; B29L 2031/34

(57) ABSTRACT

In an embodiment, a method for assembling an RFID device is disclosed. In the embodiment, the method involves placing an adhesive on an antenna structure of an RFID device, the antenna structure including a substrate, an antenna formed on the substrate, the antenna having a first end and a second end that are separated, placing an integrated circuit (IC) device on the adhesive such that the first end of the antenna is electrically coupled to the second end of the antenna via the IC device, and applying a trigger to at least one of the first end and the second end of the antenna to cause the antenna to become heated, which causes the adhesive to cure.

### BACKGROUND

The assembly of radio-frequency identification (RFID) devices typically utilizes a serial assembly line process in which several RFID devices move rapidly through steps of the serial assembly process. For example, assembly can involve depositing an adhesive on an antenna structure, placing an integrated circuit (IC) device on the antenna structure, and curing the adhesive to secure the IC device to the antenna structure.

### SUMMARY

In an embodiment, a method for assembling an RFID device is disclosed. In the embodiment, the method involves placing an adhesive on an antenna structure of an RFID device, the antenna structure including a substrate, an antenna formed on the substrate, the antenna having a first end and a second end that are separated, placing an integrated circuit (IC) device on the adhesive such that the first end of the antenna is electrically coupled to the second end of the antenna via the IC device, and applying a trigger to at least one of the first end and the second end of the antenna to cause the antenna to become heated, which causes the adhesive to cure.

In another embodiment, the trigger is applied from a single direction.

In another embodiment, heat from the antenna is delivered from under the IC device.

In another embodiment, applying the trigger comprises applying electrical current to the antenna.

In another embodiment, applying the trigger comprises applying a laser beam to the antenna.

In another embodiment, applying the trigger comprises applying infrared light to the antenna.

In another embodiment, applying the trigger comprises applying a heat thermode to the antenna.

In another embodiment, applying the trigger comprises applying microwaves to the antenna.

In another embodiment, applying electrical current to the antenna comprises applying an electrode to each end of the antenna to apply a voltage across the antenna.

In another embodiment, a method for assembling an RFID device is disclosed, In the embodiment, the method involves placing an adhesive on an antenna structure of an RFID device, the antenna structure including a substrate, an antenna formed on the substrate, the antenna having a first end and a second end that are separated, placing an integrated circuit (IC) device on the adhesive such that the first end of the antenna is electrically coupled to the second end of the antenna via the IC device, and applying heat to at least one of the first end and the second end of the antenna to cause the antenna to become heated, which causes the adhesive to cure.

In another embodiment, the trigger is applied from a single direction.

In another embodiment, heat from the antenna is delivered from under the IC device.

In another embodiment, a method for assembling an RFID device is disclosed. In the embodiment, the method involves placing an adhesive on an antenna structure of an RFID device, the antenna structure including a substrate, an antenna formed on the substrate, the antenna having a first end and a second end that are separated, placing an integrated circuit (IC) device on the adhesive such that the first end of the antenna is electrically coupled to the second end of the antenna via the IC device, and applying a trigger in a single direction from under the IC device to at least one of the first end and the second end of the antenna to cause the antenna to become heated, which causes the adhesive to cure.

In another embodiment, applying the trigger comprises applying electrical current to the antenna.

In another embodiment, applying the trigger comprises applying a laser beam to the antenna.

In another embodiment, applying the trigger comprises applying infrared light to the antenna.

In another embodiment, applying the trigger comprises applying a heat thermode to the antenna.

In another embodiment, applying the trigger comprises applying microwaves to the antenna.

Other aspects and advantages of embodiments of the present invention will become apparent from the following detailed description taken in conjunction with the accompanying drawings.

### BRIEF DESCRIPTION OF THE DRAWINGS

FIG. 1 depicts an assembly system that includes an adhesive subsystem, a chip placement subsystem, and a curing subsystem.

FIG. 2 depicts a section of a flexible substrate that includes antennas for RFID devices that can be assembled using the assembly system of FIG. 1.

FIG. 3 depicts an expanded view of a portion of an antenna from FIG. 2.

FIG. 4 illustrates a typical technique for curing adhesive.

FIGS. 5A through 5C illustrate a technique for attaching an IC device to an antenna in accordance with an embodiment of the invention.

FIG. 6 is a side view of the application of a trigger.

FIG. 7 is a flow chart diagram of a process for assembling an RFID device.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

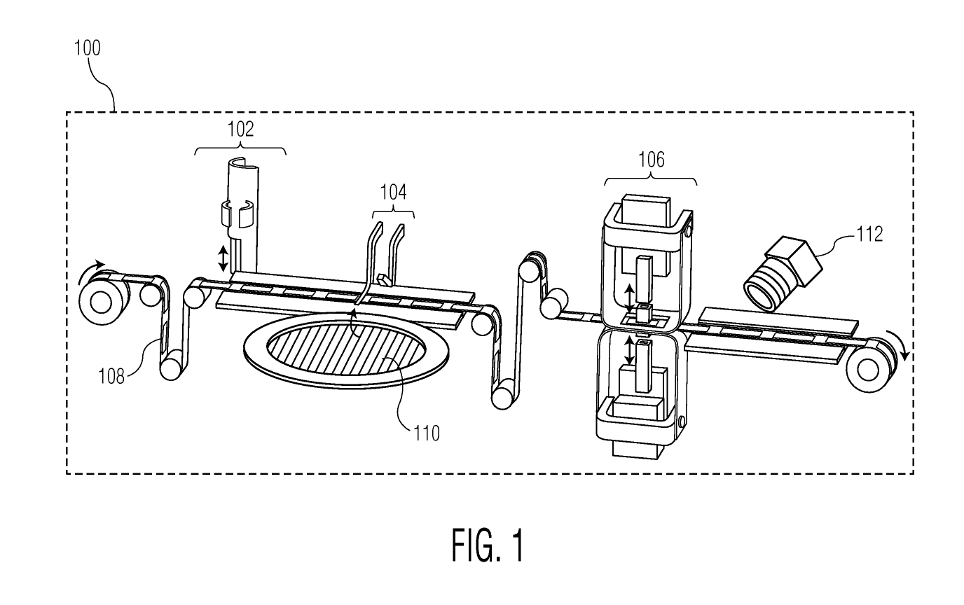

FIG. 1 depicts an assembly system 100 that includes an adhesive subsystem 102, a die placement subsystem 104, and a curing subsystem 106. In an embodiment, the assembly system serially processes antennas formed on a flexible substrate 108. In an embodiment, the flexible substrate on which the antennas are formed is fed into the assembly system. Assembly systems typically buffer a length of flexible substrate to allow batch processing. If an assembly system utilizes a higher unit per hour (UPH) rate, then a larger length of flexible substrate will be held in the buffer than when a lower UPH rate is used. For example, an assembly system processing twenty thousand units per hour utilizing fifty thermodes will utilize a large buffer. When the flexible substrate is drawn from the bummer, the adhesive subsystem deposits adhesive on the substrate and/or on an antenna on the substrate. Once the adhesive is deposited, the die placement system picks an integrated circuit (IC) device off of a wafer 110 and places the IC device on the adhesive to electrically connect a first end of an antenna to a second end of the antenna via the IC device. After the IC device has been placed, the curing subsystem delivers heat to the adhesive to cure the adhesive and secure the IC device to the antenna. In an embodiment, a camera 112 (or multiple cameras) is used to insure proper alignment during the operations performed by each subsystem. Because the assembly process is serial, the operation of each subsystem affects the timing of other subsystems in the process. Accordingly, if one subsystem takes longer than the other subsystems in the process, the other subsystems in the process are delayed and the assembly time for each device is similarly delayed. Thus, the subsystem that takes the longest to perform its function can become a bottleneck in the assembly process. In an embodiment, the curing subsystem is often times the bottleneck in the process.

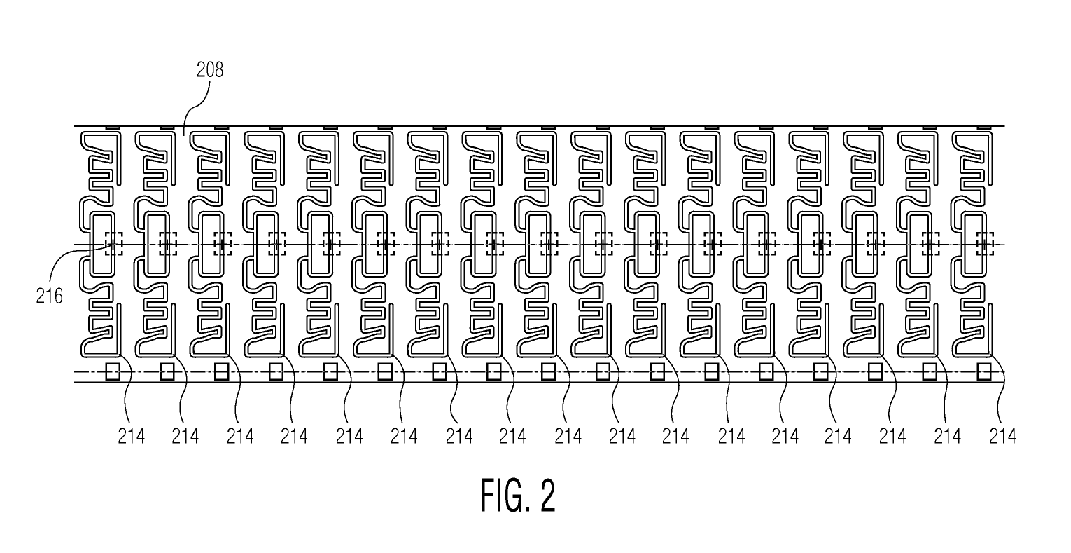

FIG. 2 depicts a section of a flexible substrate 208 that includes antennas 214 for RFID devices that can be assembled using the assembly system of FIG. 1. In an embodiment, the flexible substrate is polyethylene terephthalate (PET), polyethylenenaphthalate (PEN), polyimide (PI), paper, foil or some other flexible substrate, having a first major surface on which antennas are formed and a second major surface opposite to the first major surface. In an embodiment, the antennas are formed on the first major surface using a highly conductive material such as aluminum or copper. The antennas are formed with a separation between a first end and a second end of each antenna. In an embodiment, the separation is located such that an RFID IC device can be attached to the antenna spanning the separation and contacting both ends of the antenna. With reference to FIG. 1, the separation between the first and second ends of an antenna is within the area identified by dotted box 216. In an embodiment, the antenna is formed using aluminum with a 9 μm thickness and a 100 μm width (±50 μm) and the first end and the second end of the antenna are separated by a 100 μm wide separation (±20 μm). In an embodiment, an RFID IC device measures 490 μm by 445 μm and has at least two electrically conductive leads that can be electrically connected to the respective ends of the antenna. In other embodiments, the dimensions of the RFID IC device can vary to a smaller or larger size depending on the memory on the device, other features on the device, and the CMOS process. As is known in the field, after the assembly process, the antennas are typically separated from each other and incorporated into other RFID devices.

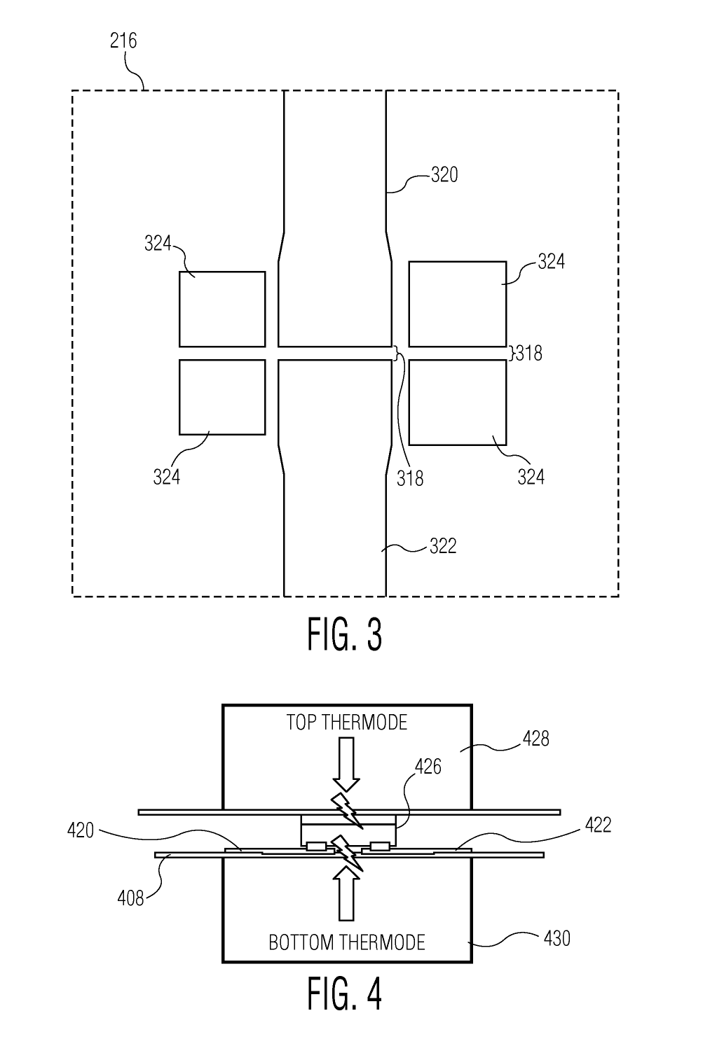

FIG. 3 depicts an expanded view of the portion 216 of the antenna 214 from FIG. 2. Typically, as shown in FIG. 3, the antenna has a first end 320 and a second end 322 that are aligned with each other, but divided by a separation 318 between the first end and the second end. In an embodiment, the separation electrically isolates the first end from the second end. In the embodiment of FIG. 3, the ends of the antenna broaden slightly at the separation. In an embodiment, alignment pads (not shown in FIG. 2) are positioned parallel to and on each side of the first end and the second end of the antenna. The alignment pads are separated by the same distance as the first end and the second end of the antenna. In an embodiment, the alignment pads are formed from the same material as the antenna and are used by the assembly system to align the antenna within each subsystem. In an embodiment, the die placement system has an alignment tolerance of +/−30 μm, but can vary depending on the speed of the system (e.g., slower system can have a lower tolerance) or the precision of manufacture (e.g., laser cut antennas). For example, in the die placement subsystem, the alignment pads are used to optically align the antenna with the die placement subsystem such that an IC device can be accurately placed over the separation to electrically couple the first end of the antenna to the second end of the antenna via the IC device. In another example, in the adhesive subsystem, the alignment pads are used to align the antenna such that the adhesive is accurately deposited.

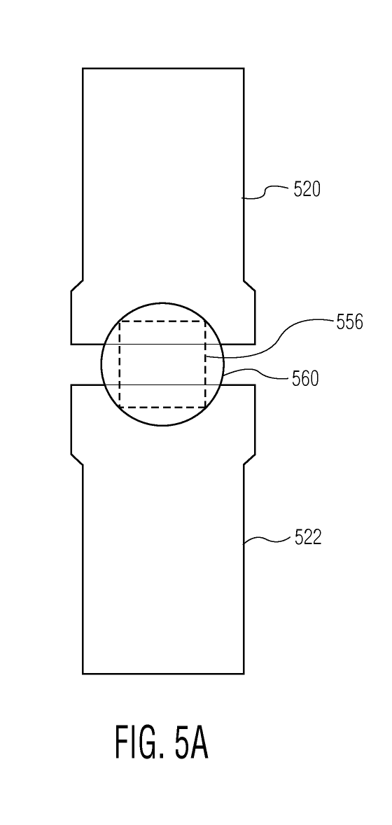

As described above, the assembly system includes a subsystem for curing adhesive. FIG. 4 illustrates a typical technique for curing adhesive. In the example of FIG. 4, an IC device 426 is placed such that it is touching or otherwise electrically coupled to a first end 420 and a second end 422 of an antenna that is formed on a substrate 408. A top thermode 428 is applied to the top surface of the IC device and a bottom thermode 430 is applied to the underside of the substrate 408. The top thermode applies heat to the IC device, which transfers to the adhesive beneath the IC device. The bottom thermode applies heat to the substrate, which also transfers to the adhesive beneath the IC device. By heating the IC device and the underside of the substrate, heat transfers to the adhesive and causes the adhesive to cure, thereby securing the IC device in place. While the technique illustrated in FIG. 4 does cure the adhesive, the technique relies on the heating of components that do not necessarily need to be heated (e.g., heating the IC device and the substrate). Heating such elements takes time and, therefore, curing the adhesive is often a bottleneck in the assembly process and thus, an important factor in determining the throughput of the assembly process.

In accordance with an embodiment of the invention, a method for assembling an

RFID device is disclosed. In the embodiment, the method involves placing an adhesive on an antenna structure of an RFID device, the antenna structure including a substrate, an antenna formed on the substrate, the antenna having a first end and a second end that are separated, placing an integrated circuit (IC) device on the adhesive such that the first end of the antenna is electrically coupled to the second end of the antenna via the IC device, and applying a trigger to at least one of the first end and the second end of the antenna to cause the antenna to become heated, which causes the adhesive to cure.

The above-described technique enables heat to be applied to the adhesive before an IC device on the adhesive is heated, which reduces the curing time and thus increases throughput. In an example operation, a trigger is applied to the first end and/or the second end of the antenna causing the antenna to heat up such that heat is delivered to the adhesive underneath the IC device (once placed). Delivering heat directly to the adhesive reduces the time needed to cure the adhesive because time is not spent heating other components, such as the IC device or the substrate before heat is delivered to the adhesive. Thus, the entire assembly process can be expedited.

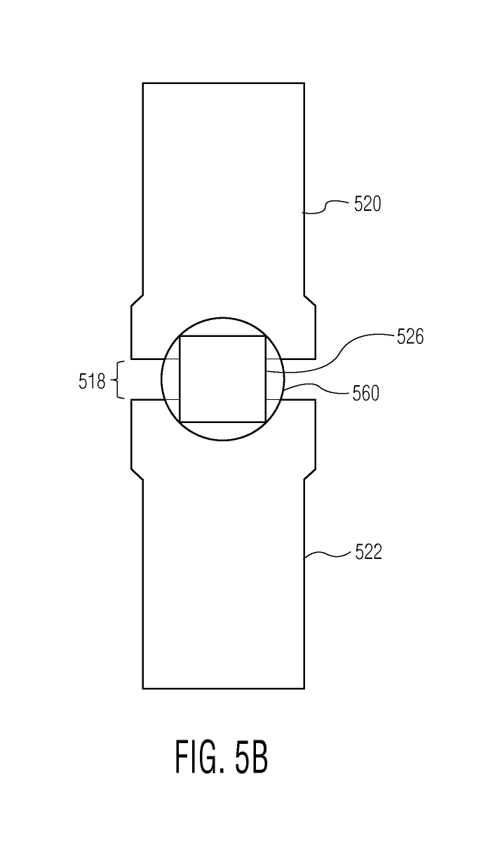

FIGS. 5A through 5C illustrate a technique for attaching an IC device to an antenna in accordance with an embodiment of the invention. As illustrated in FIG. 5A, an adhesive 560 is deposited on an antenna structure including a first end and a second end of an antenna formed on a substrate. In an embodiment, the adhesive is an acrylic glue (e.g., Delo AC365 or Delo AC265), but other adhesives can be used as well. In the embodiment of FIG. 5A, the adhesive is deposited on the antenna structure centered on where the IC device will be placed (as indicated by the footprint 556). In an embodiment, the adhesive is applied by an adhesive subsystem of an assembly system such as the adhesive subsystem 102 of the assembly system 100 as illustrated in FIG. 1. As illustrated in FIG. 5B, an IC device 526 is placed on the adhesive 560 such that the IC device spans the separation 518 between the two ends of the antenna 520, 522. In an embodiment the IC device is placed on the adhesive by a die placement subsystem 104 of the assembly system as illustrated in FIG. 1.

After the IC device is placed, a trigger is applied to the first end and the second end of the antenna. In an embodiment, the trigger, which is illustrated in FIG. 5C by circles 562A and 562B, can be applied from a single direction (e.g., top down or bottom up). For example, the trigger can be applied by applying a heat thermode to the top side of the first end and the second end of the antenna to heat up the antenna. In an embodiment, the trigger can be applied to the first end or the second end of the antenna without applying the trigger to the other end. For example, a laser beam can be applied to the top side of the first end of the antenna to heat up the antenna (e.g., as illustrated by just circle 662A). In an embodiment, the trigger can be applied by a curing subsystem configured in accordance with an embodiment of the invention that can replace a curing subsystem 106 in the assembly system 100 as illustrated in FIG. 1.

With reference to FIG. 5C, once the trigger is applied to the ends of the antenna 520, 522, the antenna begins to heat up and delivers heat to the adhesive 560. At least a portion of the antenna is in contact with the adhesive (e.g., the adhesive is deposited on the portion of the antenna) and under the IC device 526. Because the antenna is in contact with the adhesive, heat is delivered to the adhesive by the antenna rather than via an IC device or substrate, which allows for quicker curing with less heat than is needed by curing techniques such as the technique described with reference to FIG. 4. Less heat is needed because, for example, heat transfers from the material of the antenna (e.g., aluminum) to the adhesive more efficiently than from the IC device (e.g., including a ceramic package) or from the substrate (e.g., a type of paper or plastic) to the adhesive. Accordingly, the entire assembly process can be expedited.

In other embodiments, the trigger can be a laser beam applied to an end of the antenna, infrared light applied to an end of the antenna, a heat thermode applied to an end of the antenna, and/or microwaves applied to an end of the antenna. In other embodiments, other triggers are also possible.

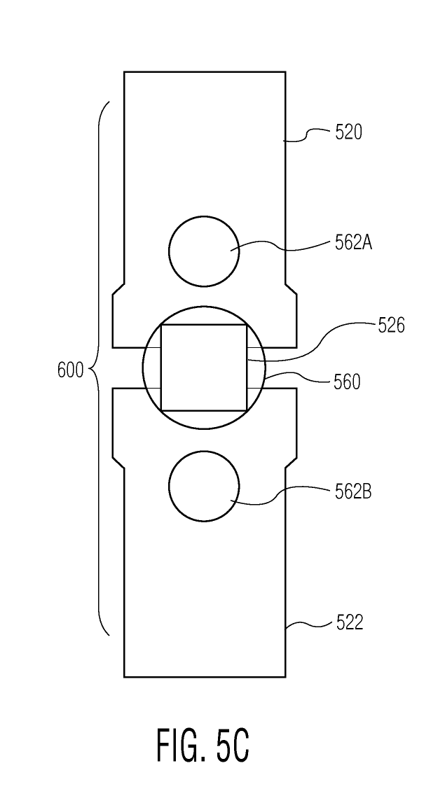

FIG. 6 is a side view of the application of a trigger. FIG. 6 illustrates an antenna on a guidance platform 654 (which is part of the assembly system 100), an IC device 626 placed on the antenna, and a trigger source 670 with two application heads 672 that apply the trigger to the two ends of the antenna 620, 622 (e.g., as illustrated in FIG. 5C by circles 562A and 562B). In an embodiment, the IC device is physically separated from the trigger source such that the trigger is delivered to the antenna via the two application heads before other elements of an RFID device (e.g., the IC device) are heated. A second trigger source is not needed because sufficient heat can be generated by the antenna when the trigger is applied by the single trigger source. Accordingly, the number of trigger sources needed in an assembly system can be reduced as compared to traditional assembly systems. In an embodiment, the trigger applied by the application heads causes the antenna to heat up without having to first heat the IC device or the substrate on which the antenna is formed. The antenna delivers heat to the adhesive and cures the adhesive on which the IC device is placed. In an embodiment, during the curing process, the application heads apply the trigger via direct contact with the antenna, but, in other embodiments, the application heads can apply the trigger without direct contact (e.g., application of a laser beam to the antenna).

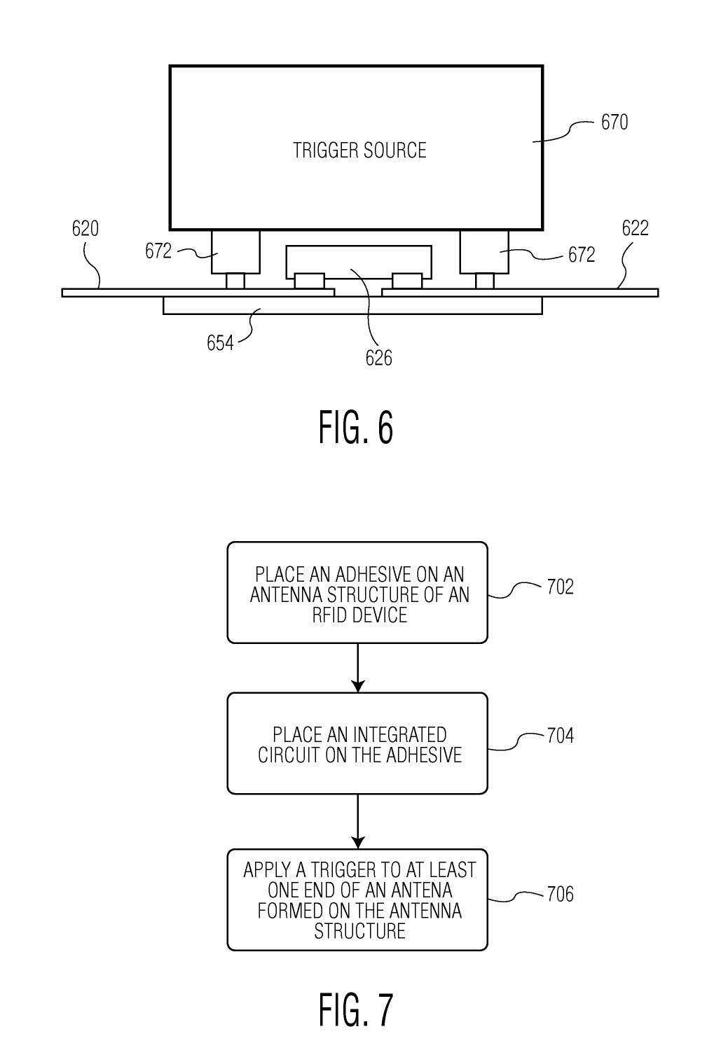

FIG. 7 is a flow chart diagram of a process for assembling an RFID device. At block 702, adhesive is placed on an antenna structure of an RFID device. In an embodiment, the antenna structure includes a substrate and an antenna is formed on the substrate with a first end and a second end that are separated. In an embodiment, the adhesive is applied by an adhesive subsystem that is part of an assembly system. At block 704, an integrated circuit (IC) device is placed on the adhesive. In an embodiment, the IC device is placed by a die placement system of the assembly system. The IC device is placed such that the IC device spans the separation between the first and second end of the antenna and electrically connects the first end with the second end of the antenna. At block 706, a trigger is applied to one end of the antenna formed on the substrate. In an embodiment, application of the trigger causes the antenna to heat up and deliver heat to the adhesive. In an embodiment, the trigger can be applied to more than one end of the antenna and applying the trigger to heat up the antenna allows heat to be delivered to the adhesive before heating the IC device or the substrate.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

In an embodiment, electrically separate means that there is no conductive path between two elements (e.g., between the heating element and the antenna) across a non-conductive substrate.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method for assembling an RFID device, the method comprising:
placing an adhesive on an antenna structure of an RFID device, the antenna structure including:
a substrate;
an antenna formed on the substrate, the antenna having a first end and a second end that are separated;
placing an integrated circuit (IC) device on the adhesive such that the first end of the antenna is electrically coupled to the second end of the antenna via the IC device; and
applying a trigger to at least one of the first end and the second end of the antenna to cause the antenna to become heated, which causes the adhesive to cure.

2. The method of claim 1, wherein the trigger is applied from a single direction.

3. The method of claim 1, wherein heat from the antenna is delivered from under the IC device.

4. The method of claim 1, wherein applying the trigger comprises applying electrical current to the antenna.

5. The method of claim 1, wherein applying the trigger comprises applying a laser beam to the antenna.

6. The method of claim 1, wherein applying the trigger comprises applying infrared light to the antenna.

7. The method of claim 1, wherein applying the trigger comprises applying a heat thermode to the antenna.

8. The method of claim 1, wherein applying the trigger comprises applying microwaves to the antenna.

9. The method of claim 4, wherein applying electrical current to the antenna comprises applying an electrode to each end of the antenna to apply a voltage across the antenna.

10. A method for assembling an RFID device, the method comprising:
placing an adhesive on an antenna structure of an RFID device, the antenna structure including:
a substrate;
an antenna formed on the substrate, the antenna having a first end and a second end that are separated;
placing an integrated circuit (IC) device on the adhesive such that the first end of the antenna is electrically coupled to the second end of the antenna via the IC device; and
applying heat to at least one of the first end and the second end of the antenna to cause the antenna to become heated, which causes the adhesive to cure.

11. The method of claim 10, wherein the trigger is applied from a single direction.

12. The method of claim 10, wherein heat from the antenna is delivered from under the IC device.

13. A method for assembling an RFID device, the method comprising:
placing an adhesive on an antenna structure of an RFID device, the antenna structure including:
a substrate;
an antenna formed on the substrate, the antenna having a first end and a second end that are separated;
placing an integrated circuit (IC) device on the adhesive such that the first end of the antenna is electrically coupled to the second end of the antenna via the IC device; and
applying a trigger in a single direction from under the IC device to at least one of the first end and the second end of the antenna to cause the antenna to become heated, which causes the adhesive to cure.

14. The method of claim 13, wherein applying the trigger comprises applying electrical current to the antenna.

15. The method of claim 13, wherein applying the trigger comprises applying a laser beam to the antenna.

16. The method of claim 13, wherein applying the trigger comprises applying infrared light to the antenna.

17. The method of claim 13, wherein applying the trigger comprises applying a heat thermode to the antenna.

18. The method of claim 13, wherein applying the trigger comprises applying microwaves to the antenna.
